(19) United States
(12) Patent Application Publication
(10) Pub. No.: US 2018/0041465 A1
(43) Pub. Date: Feb. 8, 2018

(54) DISTRIBUTED MOBILITY MANAGEMENT SYSTEM AND METHOD

(71) Applicant: ELECTRONICS AND TELECOMMUNICATIONS RESEARCH INSTITUTE, Daejeon (KR)

(72) Inventors: Jae Ho KIM, Gyeryong-si (KR); Yoo Hwa KANG, Daejeon (KR); No Ik PARK, Daejeon (KR)

(21) Appl. No.: 15/477,175

(22) Filed: Apr. 3, 2017

(30) Foreign Application Priority Data
Aug. 5, 2016 (KR) 10-2016-0100228

(51) Int. Cl. H04L 29/12; H04W 88/08; H04W 28/08; H04L 12/741; H04W 24/10

(52) U.S. Cl. CPC H04L 61/103; H04L 45/74; H04W 24/10; H04W 28/08; H04L 61/2015; H04W 88/08

(57) ABSTRACT

A distributed mobility management method includes: receiving, by a base station, an address resolution protocol (ARP) request message from a user terminal in a heterogeneous unified network environment; generating, by the base station, a logical interface having a media access control (MAC) proxy of the base station as a link address; registering, by the base station, the logical interface with an edge unified control entity; and transmitting, by the base station, an ARP response message including the MAC proxy that the logical interface has to the user terminal.

### CROSS-REFERENCE TO RELATED APPLICATION

This application claims priority to and the benefit of Korean Patent Application No. 10-2016-0100228, filed in the Korean Intellectual Property Office on Aug. 5, 2016, the entire contents of which are incorporated herein by reference.

### BACKGROUND OF THE INVENTION

### 1. Field of the Invention

The present invention relates to a distributed mobility management system and method, and more particularly, to a technology of managing distributed mobility in a network in which a wired access network and a wireless access network such as 5G, WiFi, or the like are integrally accommodated into a single network.

### 2. Description of Related Art

A mobility management technology of a 4G network is referred to as a centralized mobility management (MM) technology of managing mobility and processing traffics in an entity called a mobility management entity (MME) and a mobility anchor such as S-GW, P-GW, or the like.

An IETF distributed mobility management (DMM) WG has progressed in a direction in which nodes performing a mobility management in an existing mobility technology (e.g., MIP, PMIP, etc.) are distributed. The DMM technology may be classified into a host-based technology and a network-based technology depending on whether or not which entity mainly performs a mobility management function, and may be classified into a fully distributed scheme and a partially distributed scheme depending on whether or not a data plane is distributed and a control plane is distributed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a distributed mobility management system and method having advantages of providing a logical interface for hiding changes of an anchor and an access network from a terminal in an environment in which gateways are horizontally distributed and various access networks are accommodated.

Objects of the present invention are not limited to the above-mentioned objects. That is, other objects that are not mentioned may be obviously understood by those skilled in the art to which the present invention pertains from the following description.

An exemplary embodiment of the present invention provides a distributed mobility management method including: receiving, by a base station, an address resolution protocol (ARP) request message from a user terminal in a heterogeneous unified network environment; generating, by the base station, a logical interface having a media access control (MAC) proxy of the base station as a link address; registering, by the base station, the logical interface with an edge unified control entity; and transmitting, by the base station, an ARP response message including the MAC proxy that the logical interface has to the user terminal.

A target internet protocol (IP) address of the ARP request message may be set to an address of the unified gateway.

Another embodiment of the present invention provides a distributed mobility management method including: performing, by a user terminal, communication with a first base station within an area of a first unified gateway in a heterogeneous unified network environment; moving, by the user terminal, within an area of a second unified gateway and accessing a second base station; registering, by the second base station, an IP address allocated to the user terminal and an IP address of the second unified gateway with an edge unified control entity; transmitting, by the edge unified control entity, logical interface information that the edge unified control entity has to the second base station; and transmitting, by the second base station, an address resolution protocol (ARP) response message to the user terminal using the received logical interface information.

The transmitting of the ARP response message may include generating, by the second base station, the ARP response message using a MAC address of the first base station included in the logical interface information and transmitting, by the second base station, the ARP response message.

The distributed mobility management method may further include: receiving, by the second base station, an ARP request message from the user terminal; generating, by the second base station, a first logical interface having a MAC proxy of the second base station as a link address; and registering, by the second base station, the first logical interface with the edge unified control entity.

Yet another embodiment of the present invention provides a distributed mobility management system including: a first base station generating a logical interface having a MAC proxy of the first base station as a link address when receiving an address resolution protocol (ARP) request message from a user terminal in a heterogeneous unified network environment, and located within an area of a first unified gateway; and an edge unified control entity receiving the logical interface from the first base station and registering the logical interface.

The distributed mobility management system may further include a second base station located within an area of a second unified gateway.

When the user terminal which is communicating with the first base station moves to access the second base station, the edge unified control entity may transmit logical interface information that the edge unified control entity has to the second base station.

The second base station may transmit an ARP response message to the user terminal using the logical interface information received from the edge unified control entity.

The second base station may generate the ARP response message using a MAC address of the first base station included in the logical interface information and transmit the ARP response message.

### BRIEF DESCRIPTION OF THE DRAWINGS

FIG. 1 is a drawing illustrating a reference model of a 5G core network according to an exemplary embodiment of the present invention.

FIG. 2 is a drawing illustrating a network structure of a distributed mobility provision environment accommodating multiple access networks according to an exemplary embodiment of the present invention.

FIG. 3 is a drawing illustrating an example of a case in which a user terminal according to an exemplary embodiment of the present invention moves within an area of the same unified gateway.

FIG. 4 is a drawing illustrating an example of a case in which the user terminal according to an exemplary embodiment of the present invention moves to an area of another unified gateway.

FIG. 5 is a drawing illustrating a process of generating a logical interface according to another exemplary embodiment of the present invention.

FIG. 6 is a drawing illustrating an example of a case in which a user terminal according to another exemplary embodiment of the present invention moves to an area of another unified gateway.

FIG. 7 is a configuration diagram of a computer system to which a home link provision technology for a distributed mobility management according to an exemplary embodiment of the present invention is applied.

### DETAILED DESCRIPTION OF THE EMBODIMENTS

Hereinafter, exemplary embodiments of the present invention will be described in detail with reference to the accompanying drawings. It is to be noted that in giving reference numerals to components of each of the accompanying drawings, the same components will be denoted by the same reference numerals even though they are shown in different drawings. In addition, when it is determined that a detailed description of known configuration or functions obscures an understanding of the present invention, the detailed description thereof will be omitted.

In describing component of the exemplary embodiments of the present invention, terms such as first, second, A, B, (a), (b), etc., may be used. These terms are used only to differentiate the components from other components. Therefore, the nature, order, sequence, etc. of the corresponding components are not limited by these terms. In addition, unless defined otherwise, it is to be understood that all the terms used in the specification including technical and scientific terms have the same meaning as those that are understood by those skilled in the art. It must be understood that the terms defined by the dictionary are identical with the meanings within the context of the related art, and they should not be ideally or excessively formally defined unless the context clearly dictates otherwise.

In the present specification, it is to be understood that when one component is referred to as being “connected to” or “coupled to” another element, it may be connected directly to or coupled directly to another element or be connected to or coupled to another element, having the other element intervening therebetween. On the other hand, in the present specification, it is to be understood that when one element is referred to as being “connected directly to” or “coupled directly to” another element, it may be connected to or coupled to another element without the other element intervening therebetween.

Further, in the present specification, singular forms may be intended to include plural forms unless the context clearly indicates otherwise.

Further, in the present specification, it will be further understood that the terms “include” or “have” used in the present specification, specify the presence of features, numerals, steps, operations, components, parts mentioned in the present specification, or a combination thereof, but do not preclude the presence or addition of one or more other features, numerals, steps, operations, components, parts, or a combination thereof.

Further, in the present specification, the term “and/or” includes a combination of a plurality of relevant items or any of a plurality of relevant items.

Further, in the present specification, a user terminal may refer to a terminal, mobile terminal, a mobile station, an advanced mobile station, a high reliability mobile station, a subscriber station, a portable subscriber station, an access terminal, user equipment, and the like and may also include all or some of the functions of the terminal, the mobile terminal, the mobile station, the advanced mobile station, the high reliability mobile station, the subscriber station, the portable subscriber station, the access terminal, the user equipment, and the like.

Further, in the present specification, a base station (BS) may refer to an advanced base station, a high reliability base station, a nodeB, an evolved node B (eNodeB, eNB), an access point, a radio access station, a base transceiver station, a mobile multihop relay (MMR)-BS, a relay station serving as a base station, a high reliability relay station serving as a base station, a repeater, a macro cell base station, a small cell base station, and the like and may also include all or some of the functions of the advanced base station, the HR-BS, the nodeB, the eNodeB, the access point, the radio access station, the base transceiver station, the MMR-BS, the relay station, the high reliability relay station, the repeater, the macro cell base station, the small cell base station, and the like.

The present invention discloses a method for generating logical interface information when a terminal is initially accessed, sharing the logical interface information when the terminal moves between base stations within a gateway, and sharing the logical interface information when the terminal moves between the gateways.

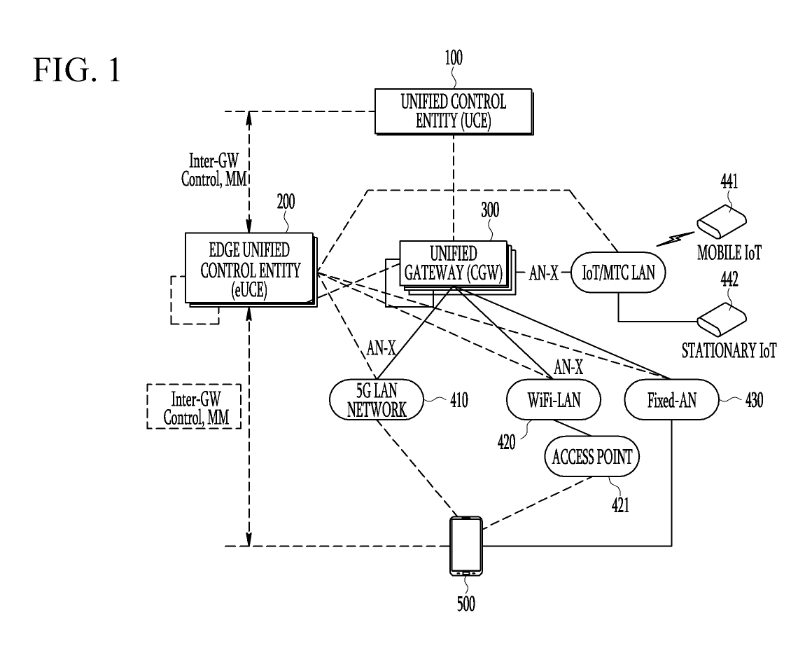

Hereinafter, exemplary embodiments of the present invention will be described in detail with reference to FIGS. 1 to 7.

In order to help an understanding of a configuration and an action of the present invention, a mobility management device and method in a 5G core network that accommodates a 5G wireless access network, a WiFi-based wireless access network, a wired access network, and a wireless access network for Internet of Thing/Machine Type Communications (IoT/MTC) in a home are described as one exemplary embodiment.

FIG. 1 is a drawing illustrating a reference model of a 5G core network according to an exemplary embodiment of the present invention.

The 5G core network according to an exemplary embodiment of the present invention includes a unified (or integrated) control entity 100, an edge unified control entity 200, a unified gateway 300, wired and wireless networks 410, 420, 430, and 440, and a user terminal 500.

The unified control entity 100, which is a unified control entity (UCE), is a node processing a control traffic. The unified control entity 100 performs an inter-GW mobility management function and an inter-GW path optimization control function through an interaction with the edge unified control entity 200.

The edge unified control entity 200, which is an edge UCE (eUCE), is a node processing a control traffic. The edge unified control entity 200 is disposed at an edge of a network for minimizing a control delay and managing hierarchical mobility, and performs a unified gateway 300 selection function and an intra-GW mobility management function. In this case, the intra-GW mobility management is classified into an intra-RAT mobility management between the same wireless access network, and an inter-RAT mobility management between different wireless access networks.

The unified gateway 300, which is a node processing a data traffic, receives routing rules for the user terminal from the unified control entity 100 and the edge unified control entity 200 to perform an internet protocol (IP) routing function. The unified gateway 300 may accommodate various access networks, and is an anchor node at the time of performing an intra-GW hand-over.

The wired and wireless networks 410, 420, 430, and 440, which are various wired and wireless access networks, include a 5G-LAN 410, a WiFi-LAN 420, a Fixed-AN 430, and an IoT/MTC LAN 440. Here, the WiFi-LAN 420 is connected to an access point 421 for a WiFi connection. The IoT/MTC LAN 440 includes a mobile IoT 441 and a stationary IoT 442. The wired and wireless networks 410, 420, 430, and 440 have a unique access interface of a wired and wireless access technology, and have a control interface with the edge unified control entity 200 and a traffic transmission interface with the unified gateway 300 with a network side.

The user terminal 500 may have a 5G wireless access interface as well as various wired and wireless access interfaces.

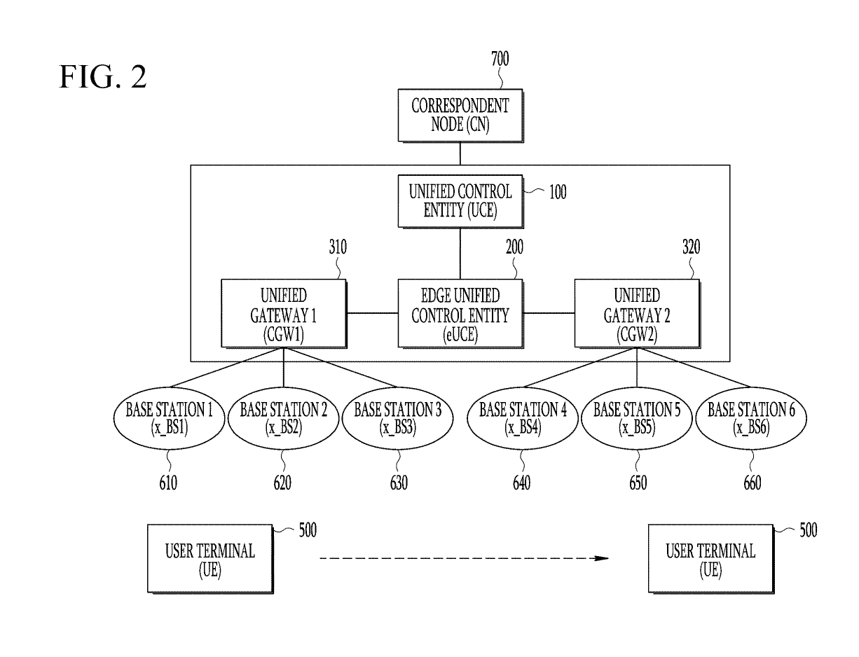

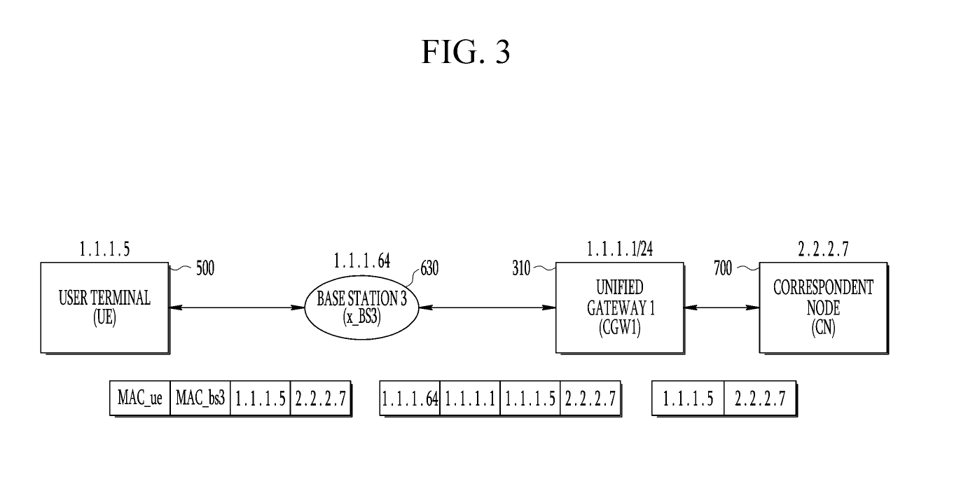

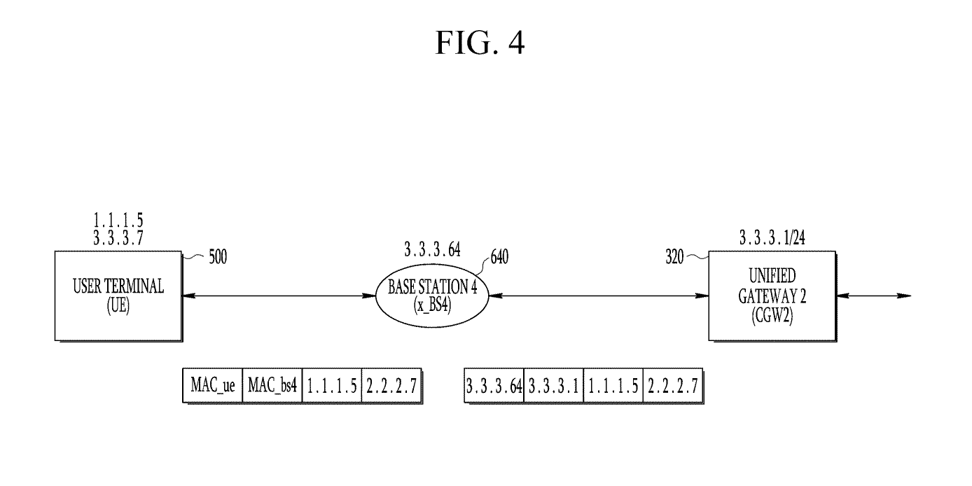

FIG. 2 is a drawing illustrating a network structure of a distributed mobility provision environment accommodating multiple access networks according to an exemplary embodiment of the present invention, FIG. 3 is a drawing illustrating an example of a case in which a user terminal according to an exemplary embodiment of the present invention moves within an area of the same unified gateway, and FIG. 4 is a drawing illustrating an example of a case in which the user terminal according to an exemplary embodiment of the present invention moves to an area of another unified gateway.

Referring to FIG. 2, the user terminal 500 communicates with a correspondent node (CN) 700 via the 5G network. The user terminal 500 accesses the network through base stations (BS) 610, 620, 630, 640, 650, and 660 of various access networks.

In the distributed mobility provision environment, the user terminal 500 is allocated with an IP address covered by a unified gateway 1 310 in which the user terminal 500 is located, and a default gateway of the user terminal 500 becomes the corresponding unified gateway 1 310. However, when the user terminal 500 transmits an uplink traffic to the correspondent node 700, the user terminal 500 may not know a media access control (MAC) address of the unified gateway 1 310, and needs to instead receive MAC addresses of the base stations 610, 620, and 630, not the MAC address of the default gateway in order to transmit IP packets through the base stations 610, 620, and 630 between the user terminal 500 and the unified gateway 1 310.

Referring to FIG. 3, the user terminal 500 is connected to the base station 3 630 by a link, and the base station 3 630 and the unified gateway 1 310 are connected to each other by a tunneling. Here, when a source IP of the user terminal 500 is 1.1.1.5, the user terminal 500 transmits a message including a MAC address (MAC_ue) of the user terminal, a MAC address (MAC_bs3) of the base station 3 630, 1.1.1.5, and 2.2.2.7, which is an IP address of the correspondent node 700, to the base station 3 630. Accordingly, the base station 3 630 transmits a message including 1.1.1.64, which is an own IP address, 1.1.1.1, which is an address of the unified gateway 1 310, 1.1.1.5, which is the source IP, and 2.2.2.7, which is the IP address of the correspondent node 700, to the unified gateway 1 310. Accordingly, the unified gateway 1 310 transmits a message including 1.1.1.5 and 2.2.2.7 to the correspondent node 700.

However, in the case in which the user terminal 500 moves to an area of another unified gateway 2 320, referring to FIG. 4, the user terminal 500 has all of an IP address of 1.1.1.5 allocated by the unified gateway 1 310 and an IP address of 3.3.3.7 allocated by the unified gateway 2 320, which causes congestion. In particular, the user terminal needs to provide mobility of an IP flow which is being communicated with the correspondent node having the IP address of 2.2.2.7 using 1.1.1.5 which is an existing address, but the user terminal (UE) attempts to perform communication using the MAC address of the base station 3 630 of FIG. 3 because there is no change in the IP address, but needs to perform the communication using a MAC address different from the existing MAC address as the connected base station is changed.

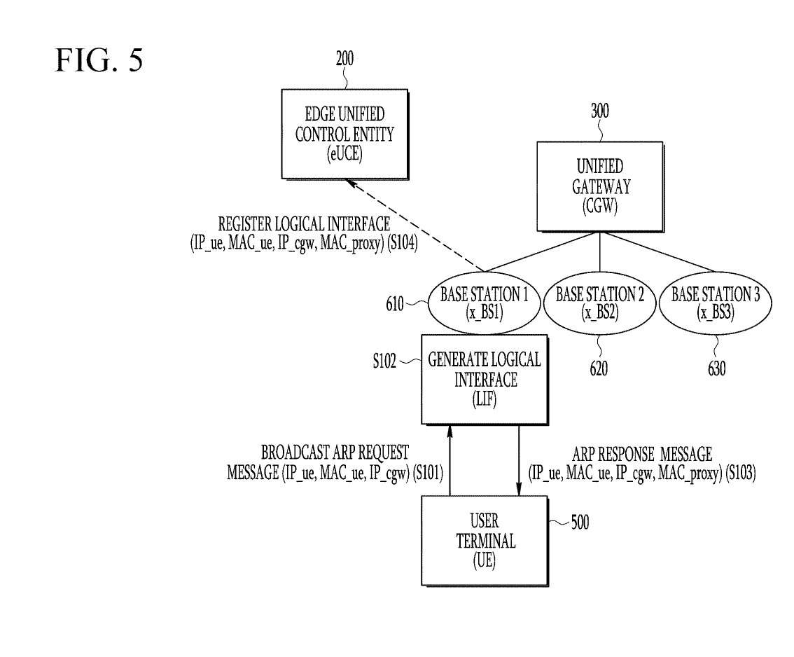

Hereinafter, a process of generating a logical interface according to another exemplary embodiment of the present invention will be described in detail with reference to FIG. 5.

Referring to FIG. 5, when the user terminal 500 initially accesses the access network, the user terminal 500 sets a target IP address of an address resolution protocol (ARP) request message to an address of the unified gateway 300, and broadcasts the ARP request message (S101).

The base station 1 (X_BS1) 610 intercepts the corresponding ARP request message broadcasted by the user terminal 500 and generates a logical interface (LIF) having a MAC proxy (MAC_proxy) of the base station 1 (X_BS1) 610 as a link address (S102).

The base station 1 (X_BS1) 610 sets the MAC address, which the LIF generated in the S102 has, to the MAC proxy (MAC_proxy) to thereby transmit an ARP response message to the user terminal 500 (S103). For example, the base station 1 (X_BS1) 610 may transmit the ARP response message including the MAC proxy that the LIF has to the user terminal 500.

In addition, the base station 1 (X_BS1) 610 transmits corresponding logical interface information to the edge unified control entity 200 and resisters the corresponding logical interface information (S104).

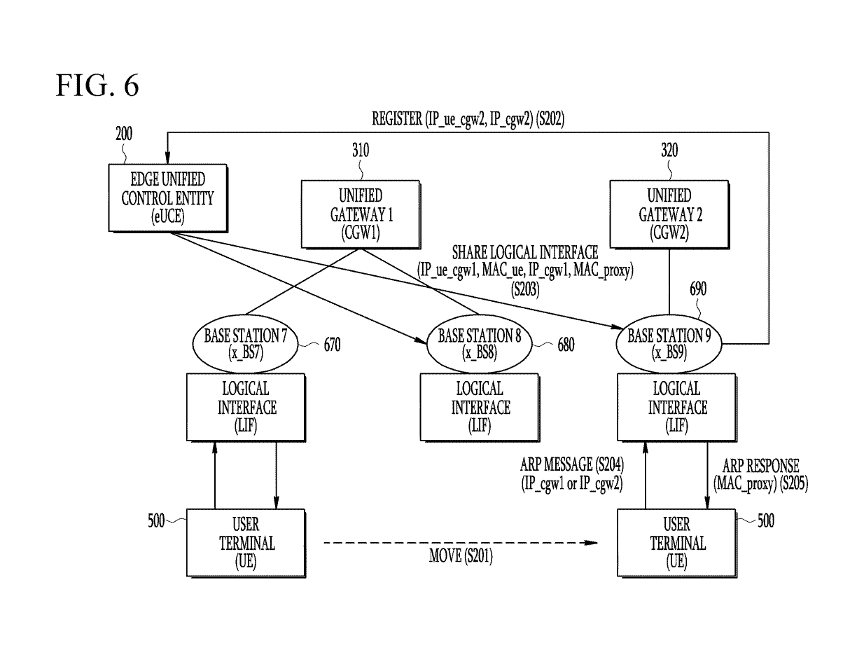

Hereinafter, a process of performing an ARP in a case in which a user terminal according to another exemplary embodiment of the present invention moves to an area of another unified gateway will be described in detail with reference to FIG. 6. FIG. 6 illustrates a process of performing an ARP in a case in which the user terminal 500 moves to a new base station within the same unified gateway or a base station of a new gateway.

In the case in which the user terminal 500 performs communication with a base station 7 (x_BS7) 670 within the area of the unified gateway 1 310 and then moves to a base station 9 (x_BS9) 690 within the area of the unified gateway 2 320, that is, in the case in which the user terminal 500 is handed-over to a new gateway (S201), the base station 9 (x_BS9) 690 registers an IP address (IP_ue_cgw2) allocated to the user terminal 500 moved to the new gateway and an address (IP_cgw2) of the unified gateway 2 320 with the edge unified control entity 200 (S202).

When the user terminal 500 performs a hand-over process, the edge unified control entity 200 transmits the logical interface information generated in FIG. 5 to the base station to which the user terminal 500 moves and shares the logical interface information (S203).

Thereafter, if the user terminal 500 transmits a first ARP request message for an IP session which is initiated and is on-going from the existing unified gateway 1 310, and a second ARP request message for an IP session which is initiated from a new unified gateway 2 320 (S204), the base station 9 (x_BS9) 690 always responds with the same MAC address (MAC_proxy) generated at the time of an initial access based on the logical interface (LIF) information shared from the edge unified control entity 200 (S205). For example, when the base station 9 (x_BS9) 690 receives the first ARP request message from the user terminal 500, the base station 9 (x_BS9) 690 may generate the ARP response message using the MAC address of the base station 7 (x_BS7) 670 included in the LIF information and may transmit the ARP response message to the user terminal 500. For example, when the base station 9 (x_BS9) 690 receives the second ARP request message from the user terminal 500, the base station 9 (x_BS9) 690 may generate a logical interface having a MAC proxy of the base station 9 (x_BS9) 690 as a link address, may register the generated logical interface with the edge unified control entity 200, and may transmit the ARP response message including the MAC proxy that the generated logical interface has to the user terminal 500.

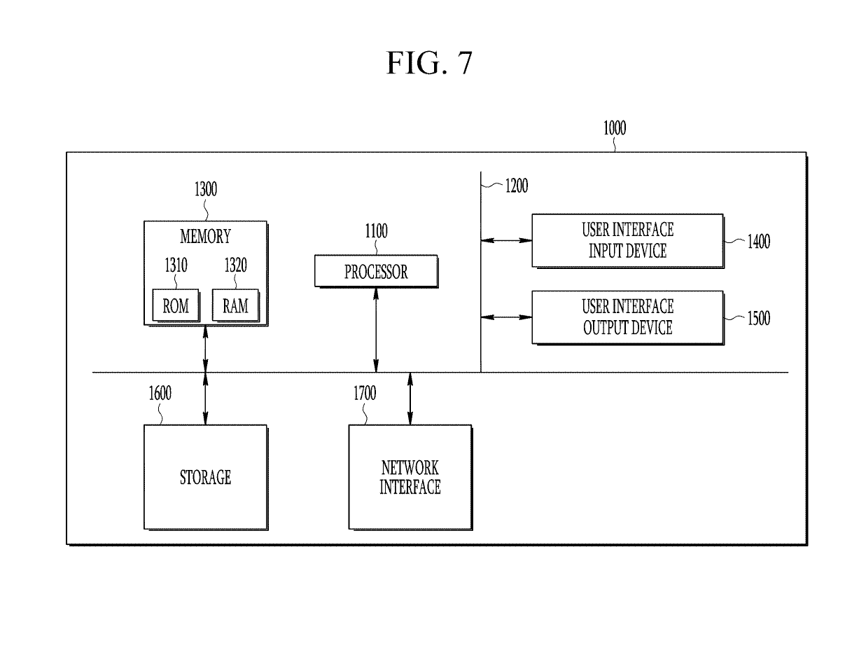

FIG. 7 is a configuration diagram of a computer system to which a home link provision technology for a distributed mobility management according to an exemplary embodiment of the present invention is applied.

Referring to FIG. 7, a computing system 1000 may include at least one processor 1100, a memory 1300, a user interface input device 1400, a user interface output device 1500, a storage 1600, and a network interface 1700 which are connected through a bus 1200.

The processor 1100 may be a central processing unit (CPU) or a semiconductor device executing processes for instructions which are stored in the memory 1300 and/or the storage 1600. The memory 1300 and the storage 1600 may include various kinds of volatile or non-volatile storing media. For example, the memory 1300 may include a read only memory (ROM) and a random access memory (RAM).

Accordingly, steps in the method or algorithm which is described in connection with the exemplary embodiments disclosed in the present specification may be directly implemented in hardware, a software module, or a combination thereof which is executed by the processor 1100. The software module may be resided on a storing medium (i.e., the memory 1300 and/or the storage 1600) such as a RAM memory, a flash memory, a ROM memory, an erasable programmable read only memory (EPROM), an electrically erasable programmable read only memory (EEPROM), a register, a hard disk, a removable disk, or a compact disc-read only memory (CD-ROM).

An exemplary storing medium may be coupled to the processor 1100 and the processor 1100 may read information from the storing medium and write the information into the storing medium. Alternatively, the storing medium may be integral with the processor 1100. The processor and the storing medium may also be resided within an application specific integrated circuit (ASIC). The ASIC may also be resided within a user terminal. Alternatively, the processor and the storing medium may also be resided within the user terminal as an individual component.

According to an embodiment of the present invention, it is possible to always provide the same logical link to the terminal in the environment in which the gateways are distributed.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

The spirit of the present invention has been merely exemplified. It will be appreciated by those skilled in the art that various modifications and alterations can be made without departing from the essential characteristics of the present invention.

Accordingly, the exemplary embodiments disclosed in the present invention do not limit but describe the spirit of the present invention, and the scope of the present invention is not limited by the exemplary embodiments. The scope of the present invention should be interpreted by the following claims and it should be interpreted that all spirits equivalent to the following claims fall within the scope of the present invention.

What is claimed is:

1. A distributed mobility management method comprising:
receiving, by a base station, an address resolution protocol (ARP) request message from a user terminal in a heterogeneous unified network environment;
generating, by the base station, a logical interface having a media access control (MAC) proxy of the base station as a link address;
registering, by the base station, the logical interface with an edge unified control entity; and
transmitting, by the base station, an ARP response message including the MAC proxy that the logical interface has to the user terminal.

2. The distributed mobility management method of claim 1, wherein:
a target internet protocol (IP) address of the ARP request message is set to an address of the unified gateway.

3. A distributed mobility management method comprising:
performing, by a user terminal, communication with a first base station within an area of a first unified gateway in a heterogeneous unified network environment;
moving, by the user terminal, within an area of a second unified gateway and accessing a second base station;
registering, by the second base station, an internet protocol (IP) address allocated to the user terminal and an IP address of the second unified gateway with an edge unified control entity;
transmitting, by the edge unified control entity, logical interface information that the edge unified control entity has to the second base station; and
transmitting, by the second base station, an address resolution protocol (ARP) response message to the user terminal using the received logical interface information.

4. The distributed mobility management method of claim 3, wherein:
the transmitting of the ARP response message includes:
generating, by the second base station, the ARP response message using a media access control (MAC) address of the first base station included in the logical interface information; and
transmitting, by the second base station, the ARP response message.

5. The distributed mobility management method of claim 3, further comprising:
receiving, by the second base station, an ARP request message from the user terminal;
generating, by the second base station, a first logical interface having a MAC proxy of the second base station as a link address; and
registering, by the second base station, the first logical interface with the edge unified control entity.

6. A distributed mobility management system comprising:
a first base station generating a logical interface having a media access control (MAC) proxy of the first base station as a link address when receiving an address resolution protocol (ARP) request message from a user terminal in a heterogeneous unified network environment, and located within an area of a first unified gateway; and
an edge unified control entity receiving the logical interface from the first base station and registering the logical interface.

7. The distributed mobility management system of claim 6, further comprising:
a second base station located within an area of a second unified gateway.

8. The distributed mobility management system of claim 7, wherein:
the edge unified control entity transmits logical interface information that the edge unified control entity has to the second base station when the user terminal which is communicating with the first base station moves to access the second base station.

9. The distributed mobility management system of claim 8, wherein:
the second base station transmits an ARP response message to the user terminal using the logical interface information received from the edge unified control entity.

10. The distributed mobility management system of claim 9, wherein:
the second base station generates the ARP response message using a MAC address of the first base station included in the logical interface information and transmits the ARP response message.
